(19) United States
(12) Patent Application Publication
(10) Pub. No.: US 2023/0268770 A1
(43) Pub. Date: Aug. 24, 2023

(54) SYSTEMS AND METHODS FOR WIRELESS BATTERY CHARGING USING CIRCUIT MODELING

(71) Applicant: Iontra Inc, Denver, CO (US)

(72) Inventors: John Richard HOWLETT, III, Centennial, CO (US); David KESSNER, Denver, CO (US)

(21) Appl. No.: 18/111,878

(22) Filed: Feb. 20, 2023

Related U.S. Application Data
(60) Provisional application No. 63/311,751, filed on Feb. 18, 2022.

(51) Int. Cl. H02J 50/10; H02J 7/02; H02J 7/00

(52) U.S. Cl. CPC H02J 50/10; H02J 7/02; H02J 7/0047; H02J 7/00032

(57) ABSTRACT

A system for wirelessly charging a battery comprising a switch operably coupled with a power supply. An inductor element, which may be part of a transformer element, which may be a part of filter, is in operable communication with the switch. The transformer is formed when two inductive elements are proximately positioned and provide a wireless charging interface. The system includes a processor in communication with the switch and in communication with a model of the inductor, which may include the transformer. The processor is configured to execute instructions to control the switch to generate a sequence of pulses at the inductor to produce a shaped charge waveform responsive to running the model to generate the shaped charge waveform.

### CROSS-REFERENCE TO RELATED APPLICATION

This application is related to and claims priority under 35 U.S.C. § 119(e) from U.S. Patent Application No. 63/311,751, filed Feb. 18, 2022, titled “Systems and Methods for Wireless Battery Charging Using Circuit Modeling,” the entire contents of which is incorporated herein by reference for all purposes.

### TECHNICAL FIELD

Embodiments of the present invention generally relate to systems and methods for wirelessly charging a battery, and more specifically for the generation of a shaped charging signal involving a wireless interface between a charger and a device. The charger may include a model of circuit components, including the wireless interface, involved in shaping the signal and/or filtering unwanted frequency components from the signal prior to application to the battery.

### BACKGROUND AND INTRODUCTION

Countless different types of electrically powered devices, such as power tools, mobile computing and communication devices, portable electronic devices, and electrically powered vehicles of all sorts including scooters and bicycles, use rechargeable batteries as a source of operating power. Rechargeable batteries are limited by finite battery capacity and must be recharged upon depletion. Recharging a battery may be inconvenient as the powered device must often be stationary during the time required for recharging the battery. Depending on battery size, recharging can take hours. Moreover, battery charging is often accompanied by degradation of battery performance. As such, significant effort has been put into developing battery charging technology to reduce the time needed to recharge the battery, improve battery performance, reduce degradation of the battery from charging, among other things.

It is with these observations in mind, among others, that various aspects of the present disclosure were conceived.

### SUMMARY

Aspects of the present disclosure involve a system for wirelessly charging a battery including a first switch operably coupled with a power supply. The system further involves a first inductive element, which may be an inductor, inductors coupled in series or parallel or combinations thereof, a transformer or inductive portion of a transformer such as the primary or secondary windings of a transformer, among other possible inductive elements, in operable communication with the first switch. The system further includes a processor in communication with the switch and in communication with a model of the inductive element. Additional components may also be modeled. The processor is configured to execute instructions to control the switch to generate a sequence of pulses at the first inductive element to produce a shaped charge waveform responsive to running the model to generate the shaped charge waveform.

In one arrangement specifically configured for wireless charging, aspects involve a switch and a transformer in operable communication with the switch. A processor of some form is in communication with the switch and in communication with a model of the transformer, the processor is configured to execute instructions to control the switch to generate a sequence of pulses at the transformer to produce a shaped charge waveform responsive to running the model to generate the shaped charge waveform, which is then applied to a battery.

The transformer may be formed by a first inductor, which may be on a charger side of a system, and a second inductor, which may be on the device side of the system where the device includes the battery to be charged. The proximate positioning of the inductors, which may include an air gap therebetween, forms the transformer. As will be recognized, the transformer may be of various possible configurations depending on the arrangement, number, number of turns, relative number of turns, etc., between the inductors on either side of the arrangement.

In various aspects, the processor may further be configured to execute the sequence of pulses with the model and adjust the sequence of pulses to produce the shaped waveform. Other features may be modeled. In one example, the model comprises a configurable inductance value and a configurable resistance value, which may be representative of at least the transformer. The processor may further be configured to execute instructions to calibrate the model by applying a known signal to the transformer and obtaining a first measurement (e.g., current or voltage) at a first point on the known signal and a second measurement (e.g. current or voltage) at a second point on the known signal, and changing at least one of the configurable inductance value or the configurable resistance value when at least one of the first measurement at the first point or the second measurement at the second point does not match a respective first intended measurement at the first point or a second intended measurement at the second point.

A battery may be operably coupled with the transformer or more generally the filter, in various possible embodiments, and receives the shaped charge waveform. The various embodiments are shaping the charge waveform and are not applying a conventional constant current or constant voltage type charge signal although it is conceivable that at times the signal will be shaped as a constant signal.

In another aspect, a capacitor may be operably coupled with the power supply and the first switch. The capacitor being configured and arranged to deliver energy, e.g., shapable current, through the switch to produce the shaped charge waveform by way of the transformer and be a modeled element of the system.

In another aspect of the present disclosure, a method of charging a battery comprises, from a processor in communication with a switch and in communication with a model of a filter comprising a transformer coupled with the switch, controlling the switch to generate a sequence of pulses at the filter to produce a shaped charge waveform responsive to running the model to generate the shaped charge waveform. The method may further involve generating a sequence of pulses at the filter element to produce a known signal from the filter; and when a measured attribute of the known signal does not match an intended measurement, calibrating the model by adjusting at least one attribute of the model.

In yet another aspect, a system for charging a battery involves a first switch receiving power by way of a wireless interface. The system also includes a first inductor in operable communication with the switch. The system further includes a processor in communication with the first switch and in communication with a model including the first inductor, the processor configured to execute instructions to control the switch to generate a sequence of pulses at the first inductor to produce a shaped charge waveform responsive to running the model to generate the shaped charge waveform.

These and other aspects of the present disclosure are described in further detail below.

### BRIEF DESCRIPTION OF THE DRAWINGS

The various objects, features, and advantages of the present disclosure set forth herein will be apparent from the following description of embodiments of those inventive concepts, as illustrated in the accompanying drawings. It should be noted that the drawings are not necessarily to scale and may be representative of various features of an embodiment, the emphasis being placed on illustrating the principles and other aspects of the inventive concepts. Also, in the drawings the like reference characters may refer to the same parts or similar throughout the different views. It is intended that the embodiments and figures disclosed herein are to be considered illustrative rather than limiting.

FIG. 1 is a system diagram of a wireless charging system in accordance with one embodiment.

FIG. 2 is a signal graph of an example a controlled arbitrarily shaped charge waveform for charging a battery in accordance with one embodiment.

FIG. 3 is a schematic diagram illustrating a circuit for wirelessly charging a battery in accordance with another embodiment.

FIG. 4 is a schematic diagram illustrating an alternative circuit for wirelessly charging a battery in accordance with another embodiment.

FIGS. 5A-5G are examples of wireless charging systems to generate a charge signal in accordance with one embodiment.

FIG. 6 is an example of a generated charge signal at a transformer of a filter circuit, where the generated charge signal is based on a model of the filter circuit.

FIG. 7 is an example of a test signal used to calibrate the model.

FIG. 8 is a system diagram of a wireless charging configuration according to one embodiment.

FIG. 9 is a system diagram of a diagram illustrating a wireless charging configuration where a wireless interface is distinct from a circuit element (or elements) shaping a charge signal according to one embodiment.

FIG. 10 is a diagram illustrating an example of a computing system which may be used in implementing embodiments of the present disclosure.

### DETAILED DESCRIPTION

Systems, circuits, and methods are disclosed herein for wirelessly charging (recharging) a battery. The terms charging and recharging are used synonymously herein. Aspects of the present disclosure may provide several advantages, alone or in combination, relative to conventional wired charging. The advantages and benefits, among others, may be achieved by way of a wireless interface where charge energy is transferred wirelessly. In so-called wired charging, charge energy is transferred over a physical medium (the “wire”) between the power source and the battery being charged.

Besides not requiring a conventional wired connection, the wireless charging system described herein may also generate an unconventional (non-direct current (DC)) charge signal that provides several benefits over conventional charge signals such as constant current, constant voltage and combinations of constant current and constant voltage (considered DC charging signals) or similar conventional DC charge techniques. For example, the charging techniques described herein may reduce the rate at which an anode is damaged, may reduce heat generated during charging, which may have several follow-on effects such as reducing electrode and other battery damage, reducing fire or short circuit risks, and the like. In other examples, the charging techniques described herein may allow for higher charging rates to be applied to the battery and may thus allow for faster charging. Conversely, through the systems, circuits, and methods discussed, less energy may be required to charge a battery as compared to various forms of conventional charging circuits and methods. The techniques may all optimize charge rates to be used, and which consider other issues such as cycle life and temperature. In one example, charge rates and parameters may be optimized to provide for a longer battery life and greater charging energy efficiency.

In some embodiments discussed, a system is described that may wirelessly charge a battery and generate a charge signal that is controllably shaped using a model of one or more components of a charge signal shaping circuit. Part of the shaping circuit may involve a wireless interface between a charger and the battery, or device containing the battery, that is being charged. Conventional charge techniques like constant current or constant voltage do not involve charge signal shaping and hence control is relatively straightforward, and there is no need for the modeling techniques discussed herein or more generally to shape the charge signal.

In one implementation, a charge signal shaping algorithm may provide an expected or intended charge signal for charging a battery to a circuit model. The model may be used to confirm and/or adjust the controls for generating the signal. The model may also, based on the intended charge signal, output one or more control signals to a or other components of the charge signal shaping circuit based on a modeling of the components of the charge signal shaping circuit. In some instances, aspects of the shape of the shaped charge signal may correspond to a harmonic (or harmonics) associated with an optimal transfer of energy to the battery, although the purpose of the system is to be able to efficiently generate a shaped charging signal, which may be of any arbitrary shape determined or otherwise defined by the system, and apply the same to the battery, among other goals. The shape, which may include the content of the charging signal, which may be any arbitrary shape defined by the controls, is defined and/or controlled. The control signals to the components of the charge signal shaping circuit may be based on a model of the components of the shaping circuit, including components of the wireless interface, rather than strictly based on feedback of measurements of the charge signal at the battery or of the battery itself during charging such as voltage and current, which are typical of battery charging circuits. In some instances, this approach may be referred to as a “feed-forward” technique.

The feed-forward technique of utilizing a model of the circuit to determine the control signals for defining a charge signal may provide several advantages including accuracy and speed of signal adjustment. Moreover, the arrangement may be operable with fewer components than and/or processing overhead as compared to other approaches such as a strict feedback approach thereby reducing costs, using less printed circuit board (PCB) real estate, being computationally less complicated, among other advantages.

Practically speaking, it is difficult to rely solely on a model of a circuit without some type of feedback to adjust for model errors, adjust for component drift, adjust for effects of temperature or other effects on circuit components, adjust for changes in the battery, and periodically provide additional data to the model to alter its parameters and/or output, among other things. For example, during operation of the charge circuit, aspects of the battery under charge may change in response to the state of charge (SoC), state of health (SoH), and the like. Thus, in some instances, aspects of the battery may be obtained and used to adjust the model of the circuit. The model may address various components of the circuits used to shape and filter the charge signal, and values or functionality of those components may change over time, which changes may be addressed in the model. In general, modeling of the circuit provides an estimation and predetermination of charge signals to counter the relatively slow feedback path from a battery and other sensors. The feedback path may also be wireless which may also affect the rate at which information is shared with the charger. In addition or alternatively, modeling provides a mechanism where effective signal control may be achieved without complicated signal measurement, component measurement or other feedback mechanisms, which are costly, consume valuable power and PCB real-estate, among other things. Nonetheless, the model may be occasionally updated based with feedback information to adjust the model response based on changes of the battery and/or circuit elements. Moreover, some wireless charging embodiments may not include a model.

The term “battery” in the art and herein can be used in various ways and may refer to an individual cell having an anode and cathode separated by an electrolyte, solid or liquid, as well as a collection of such cells connected in various arrangements. A battery or battery cell is a form of electrochemical device. Batteries generally comprise repeating units of sources of a countercharge and electrode layers separated by an ionically conductive barrier, often a liquid or polymer membrane saturated with an electrolyte. These layers are made to be thin so multiple units can occupy the volume of a battery, increasing the available power of the battery with each stacked unit. Although many examples are discussed herein as applicable to a battery, it should be appreciated that the systems and methods described may apply to many different types of batteries ranging from an individual cell to batteries involving different possible interconnections of cells such as cells coupled in parallel, series, and parallel and series. For example, the systems and methods discussed herein may apply to a battery pack comprising numerous cells arranged to provide a defined pack voltage, output current, and/or capacity. Moreover, the implementations discussed herein may apply to different types of electrochemical devices such as various different types of lithium batteries including but not limited to lithium-metal and lithium-ion batteries, lead-acid batteries, various types of nickel batteries, and solid-state batteries of various possible chemistries, to name a few. The various implementations discussed herein may also apply to different structural battery arrangements such as button or “coin” type batteries, cylindrical cells, pouch cells, and prismatic cells.

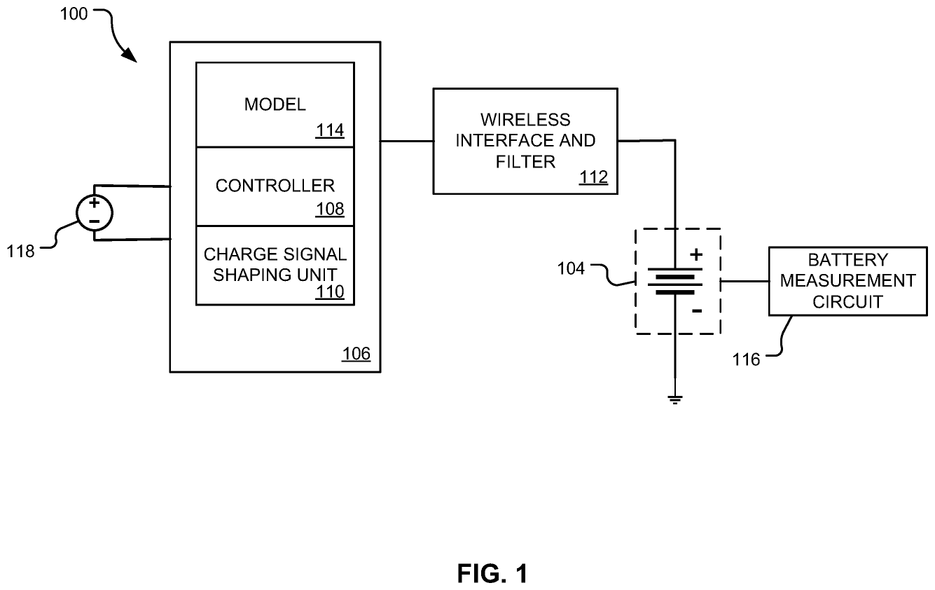

FIG. 1 is a schematic diagram illustrating an example charge signal generator arrangement 100 for wirelessly charging a battery 104. The generator includes a processing unit 106 that may include a controller 108, such as a microcontroller, FPGA (field-programmable gate array), ASIC (application-specific integrated circuit), microprocessor, state machine, combinations thereof, or other processing arrangement, that produces controls for generating a charge signal from a charge signal shaping unit 110, which controls charging over a wireless interface and filter 112. The controller is in communication with a model 114 of components of the charge signal shaping unit and/or wireless interface and filter to produce the control instructions to the charge signal shaping unit. The processing unit 106 may include discrete portions providing the controller, model, and shaping unit (e.g., an integrated unit) or various combinations of the same may be provided in separate devices. Thus, while the processing unit 106 is shown as including a controller 108, in some examples, the processing unit is the controller. The system may receive battery measurements from a battery measurement circuit 116, such as current and/or voltage measurements at battery terminals of the battery 104 in the presence of a charge signal or calibration signal or otherwise, and those battery measurements used to calibrate or adjust the model or otherwise affect charge control. The battery measurement circuit may be associated with a device including the battery or part of a battery pack or module for a device that is powered by way of the battery.

The battery measurement values may be wireless communicated to the generator 106. In general, the generator may also include or be operably coupled with a power source 118, which may be a voltage source or a current source. In one embodiment, the power source 118 is a direct current (DC) voltage source, although alternating current (AC) sources are also contemplated, which may further involve rectification to convert the AC source signal to a DC source signal. As such, in various alternatives, the power source 118 may include a DC source providing a unidirectional current, an AC source providing a bidirectional current, or a power source providing a ripple current (such as an AC signal with a DC bias to cause the current to be unidirectional. In general, the power source 118 supplies the charge energy, e.g., current, that may be shaped by the control unit 106 and filter components to produce a controllably shaped charge signal to charge the battery 104. In one example, a circuit controller 108 may provide one or more inputs to the power signal shaping circuit to generate pulses to the wireless interface and filter 112, which converts the pulses to and produces the shaped charge signal at the output of the filter to the battery. Generally, the filter converts a series of pulses into a shaped waveform. In various examples discussed herein, one aspect of the filter includes an inductor, which may be a coil of a transformer formed at the wireless interface. Other components of the filer may include various possible shunt capacitors, a second inductor, and other components illustrated in various examples herein.

In some instances, the charge signal shaping circuit 110 may alter energy from the power source 118 to generate a charge signal that is shaped based on charge conditions at the battery 104, such as a charge signal that at least partially corresponds to a harmonic or harmonics based on the impedance when a signal comprising the harmonic or attributes of the harmonic is applied to the battery 104. In the example of FIG. 1 and otherwise, the circuit 100 may include a battery measurement circuit 116 connected to the battery 104 to measure cell voltage and/or charge current, as well as other battery attributes like temperature and measure or calculate the impedance the battery 104. In one example, battery characteristics may be measured based on the applied charge signal. In another example, battery characteristics may be measured as part of a routine that applies a signal with varying harmonic frequency attributes to generate a range of battery characteristic values associated with the different frequency attributes to characterize the battery, which may involve impedance response or other similar measures like admittance, which may be done prior to charging, during charging, periodically during charging, and may be used in combination with look-up techniques, and other techniques. The battery characteristics may vary based on many physical of chemical features of the battery, including a state of charge and/or a temperature of the battery. As such, the battery measurement circuit 116 may be controlled by the circuit controller 106 to determine various battery characteristic values of the battery 104 during recharging of the, among other times, and provide the measured of battery characteristic values to the circuit controller 108 or other parts of the generator 100.

The circuit controller 108 may generate an intended charge signal for efficient charging of the battery 104. For example, a measured impedance of the battery 104 or signal definitions characterized from understanding impedance effects of signals on a battery may be used by the circuit controller 108 to generate a charge signal with attributes that correspond to a harmonic associated with a minimum impedance value of the battery 104. As such, the circuit controller 108 may execute a charge signal algorithm that outputs a charge signal shape based on measured, characterized and/or estimated charging conditions of the battery 104. The circuit controller 108 may then generate one or more control signals based on the charge signal algorithm and provide those control signals to the charge signal shaping unit 110. The control signals may, among other functions, shape the charge signal to approximate the shaped charge signal determined by the algorithm. The charge signal shaping circuit, or more particularly the wireless interface and filter, may further filter any unwanted frequency attributes from the signal. In some instances, the shaped charge signal may be any arbitrarily shaped charge signal, such that the charge signal does not conform to a traditionally repeating charge signal, such as a repeating square wave or triangle wave charge signal.

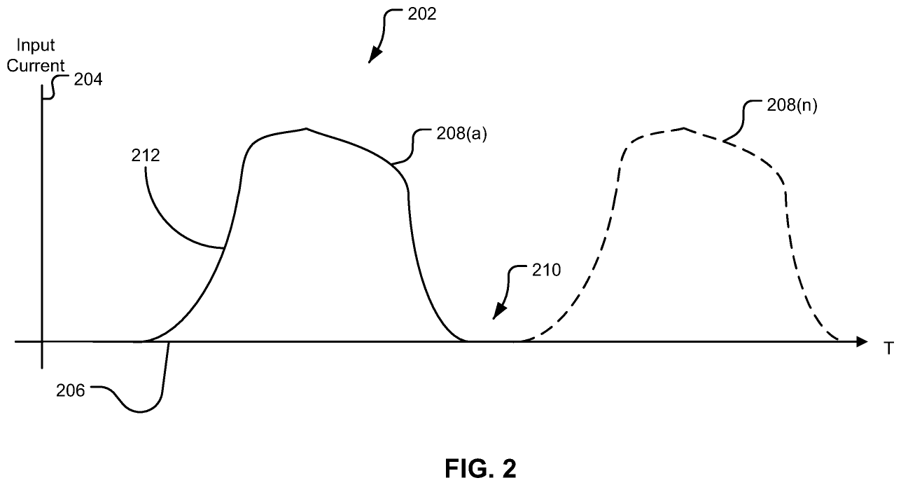

For example, FIG. 2 is a signal diagram 202 of a shaped battery charging signal 200 for charging a battery 104. The shape may be of any arbitrary shape; however, it should be appreciated that the shape is controlled, and it can take on a variety of shapes depending on the control. The signal diagram 202 illustrates a charge signal 208 graphed as input current 204 versus time 206. The shape of the charge signal 208 may be determined by a charge signal algorithm or program executed by circuit controller 106. In one instance, the shape of the charge signal 208 may be based on characteristics of the battery cell 104, such as a frequency or harmonic associated with an impedance value, which may be a minimum impedance, of the battery cell. In some examples, various parts of the shape are based on the impedance response, among other things, of different harmonics on the impedance. In many instances, the shape is based on harmonics at or around the lowest impedance, while not limited to a harmonic at the lowest impedance. For example, a leading edge 212 of the shape may correspond to a particular harmonic. In some instances, the signal, such as the signal shown in FIG. 2, may be repeating sequence of such signals (e.g., 208(a)-208(n)) between when little or no charge current 210 is applied to the battery and a period of time when charge current (e.g., signal 208(a) or 208(n)) is applied to the battery. In still another example, various aspects of the shape of the charge signal 208 may correspond to a harmonic associated with one or both of a conductance or susceptance of an admittance of the battery 104. Where impedance values are being considered, the technique assesses harmonic values where the values, alone or in combination, are at a relatively low impedance. With admittance, the techniques assess harmonics where admittance is relatively high of conductance and susceptance alone or in combination. Given the generally inverse relationship, the term impedance as used herein may include its inverse admittance. In general, the charge signal shaping algorithm of the generator 100 may sculpt or otherwise determine the shape of the charge signal 208 based on any characteristics of the battery 104, either measured, modeled, or estimated.

In some conventional charging scenarios, pulse charging has been explored. However, it has been discovered that applying a square-wave pulse charge signal to charge a battery may degrade the life of the battery or may introduce inefficiencies in the charging of the battery. For example, the abrupt application of charge current (e.g., the sharp leading edge of a square-wave pulse) to the electrode (typically the anode) of the battery may cause a large initial impedance across the battery terminals resulting in a loss of transfer of power to the battery, lessening the efficiency of the charging process and/or damaging portions of the battery under charge, among other problems.

Rapid changes in the charge signal experienced from square pulses to the battery may also introduce noise comprised of high-frequency harmonics, such as at the leading edge of the square-wave pulse, the trailing edge of the square-wave pulse, and during use of conventional reverse pulse schemes. Such high harmonics result in a large impedance at the battery electrodes. This high impedance may result in many inefficiencies and degradation of the battery, including capacity losses, heat generation, and imbalance in electro-kinetic activity throughout the battery, undesirable electro-chemical response at the charge boundary, and degradation to the materials within the battery that may damage the battery and degrade the life of the battery. Further, cold starting a battery with a sharp bonding edge pulse introduces limited faradaic activity as capacitive charging and diffusive processes set in. During this time, proximal lithium will react and be quickly consumed, leaving a period of unwanted side reactions and diffusion-limited conditions which negatively impact the health of the cell and its components. These and other inefficiencies are particularly detrimental during a relatively high current recharging of the battery typically associated with so-called fast charging.

For these and various other reasons, the shaped charge signal, when applied in a specified temperature window where charging may take place, is not a square wave or is not a square edged pulse or series of pulses involving one or more very high frequency harmonics.

As the characteristics of the battery 104 may change due to state of charge, temperature, and other factors, the shape of the charge signal 208 may also be changed over time. The signal may be defined, in part, with reference to a model 114 of the circuit components involved in generating the signal and/or filtering signal. It should be noted that components of the wireless interface may be involved in filtering or otherwise defining and shaping the charge signal. The system may also use wireless feedback. The generator may therefore, in some instances, perform an iterative process of monitoring or determining characteristics of the circuit and/or battery and adjust the model and/or shape of the charge signal 208 applied to the battery accordingly. This iterative process may improve the accuracy of signal shape and/or the efficiency of the charge signal used to recharge the battery, thereby decreasing the time to recharge the battery, extending the life of the battery (e.g., the number of charge and discharge cycles it may experience), optimizing the amount of current charging the battery, and avoiding energy lost to various inefficiencies, among other advantages.

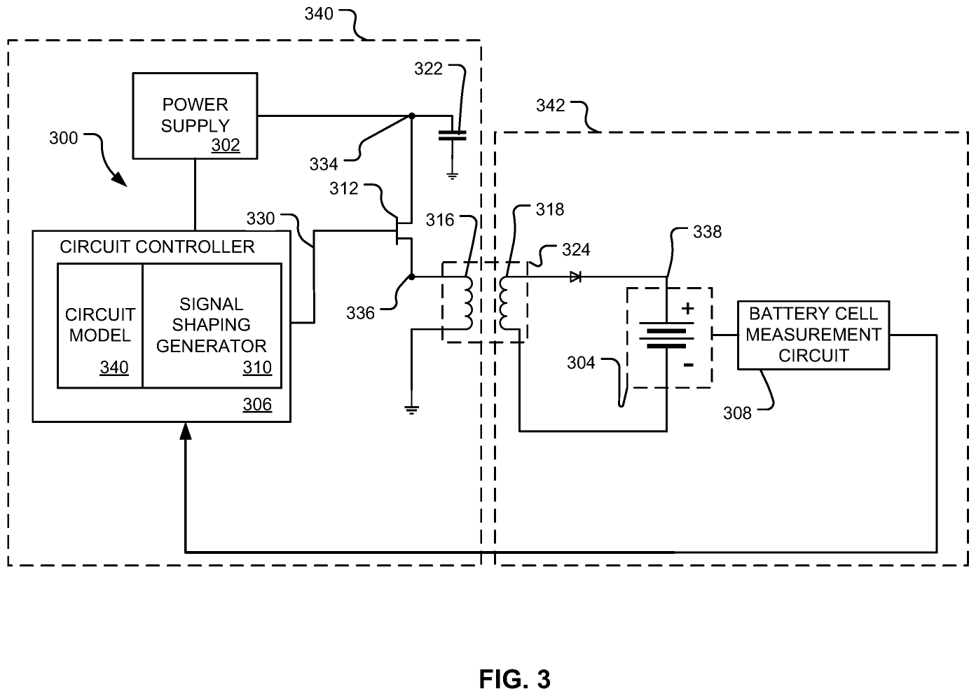

FIG. 3 is a schematic diagram illustrating a circuit 300 for charging a battery 304 utilizing a switching element 312 to generate an initial sequence of controlled pulses at node 336, which are then converted into a shaped charge signal by filter component 324, to produce a charge signal that is applied to the battery, in accordance with one embodiment. As discussed below, the filter also provides a wireless interface. The circuit 300 includes elements introduced above with reference to generator of FIG. 1, including the power supply 302, the circuit controller 306, the battery measurement circuit 308, and the battery 304.

In the example of FIG. 3, the filter component comprises a wireless interface comprising a first inductor 316 and a second inductor 318. The first inductor is part of a charger device 340 that may house the first inductor. The charger device further may comprise the switch 312, circuit controller 306 and may be coupled with or include a power supply 302. The second inductor 318 may be part of a device 342 containing the battery 304 to be charged or may be part of a battery module, including the battery, that may be operably coupled to such a device to power the device. When the inductors are positioned in operable proximity and alignment, they collectively form a transformer and may act to provide inductive charging. Here, there is no wire or other physical connection between the inductors. Instead, the inductors are positioned proximate each other, and hence the technique may be considered wireless.

Other elements illustrated in the circuit 300 of FIG. 3 may be included in charge signal shaping circuit and/or the filter of FIG. 1. As explained in more detail below, the circuit controller 306, in coordination with a circuit model, may provide one or more control signals 330 to switch of the circuit 300 as part of the process to shape a current or voltage signal to charge the battery 304. The circuit controller 306 may be implemented through a FPGA device, a microcontroller, processor, an ASIC, or any other programmable processing device. In one implementation, the circuit controller 306 may include a charge signal shaping generator 310 to control the switch to produce a sequence of pulses at node 336 that produce the shape of the charge signal to be applied to the battery 304.

As introduced above, rather than an extensive feedback environment using detailed feedback of various signal and battery characteristics, the generator may use a model. At a simple level, the model is of an inductor in series with a resistance representative of the transformer formed by the relative positioning of inductors and the resistance of filter circuit 324 as well as the battery 304. The model may thus be an inductor value in series with a resistance value. In the presence of a controlled sequence of pulses at the input to the model, the model can predict the charge signal output to the battery. So, for example, a sequence of pulses at node 336 may produce a signal like shown in FIG. 2 at the input 338 to the battery. In other examples, the model may further include a model of the switch element 312, as well as power supply 302 and capacitor 322, which may be a part of the charger. The model thus may also be able to model the control sequences to the switch that produces the input pulses to the filter 324 and analyze the modeled charge waveform produced by the model. Since various aspects of the present disclosure involve generating a carefully controlled charge waveform that is not a conventional and simple constant current, constant voltage or square edged pulse type charge signal, accurate reproduction of a targeted or planned charge signal into an actual charge signal is produced by the system. Moreover, in many charging environments the use of the model is beneficial as overly complicated measurement and feedback systems are too expensive, consume too much energy, are too slow, consume to much processor architecture real estate or the like to be practical and/or effective.

Nonetheless, particularly in the calibration sequence discussed below, the circuit controller 306 or more generally processing unit 106, may also wirelessly receive measurements of characteristics of the battery from the battery measurement circuit 308 for use in confirming the model, altering the model, and/or determining the shape of the charge signal. Moreover, in some circumstances, battery manufactures may suggest or require certain attributes of a battery be monitored, such as open circuit voltage or the like, during charging. However, as explained in more detail below, such a feedback mechanism may occur at a rate that does not allow for effective shaping of the charge signal or is performed in a way that requires less costly and complicated feedback elements such that the model may be utilized to determine the control signal 330 for controlling the elements of the circuit 300 with or without a feedback mechanism. Feedback may also occur over a wireless connection such as Bluetooth, WiFi or otherwise. In some instances, while a wireless charge (transformer) interface may be involved, a wired feedback port may be formed through a pin and socket, which may also serve to align inductors to form a repeatable transformer gap and orientation between the respective inductors.

As introduced, the circuit 300 may include one or more components to shape a charge signal for charging a battery 304. In the implementation shown, the circuit 300 may include a switching element, e.g., transistor 312, connected to an output 334 of the power supply 302. The transistor 312 may receive an input signal, such as pulse-width modulation (PWM) control signal 330, to operate the transistor 312 as a switching device or component. In general, the transistor 312 may be any type transistor, e.g., a FET or more particularly a MOSFET, a GaN FET, Silicon Carbide based FETs, or any type of controllable switching element for controllably connecting the first inductor 316 to the output 334 of the power supply 302. For example, the first transistor 312 may be a FET with a drain node connected to the first inductor 316, a source connected to the power supply 302, and a gate receiving the control signal 330 from the circuit controller. In various embodiments, the filter circuit 324 may also have various other possible inductive elements. For example, in the wireless embodiments discussed herein, the filter circuit may include the second inductor 318, which in combination with the first inductor forms a transformer, where each or both sides (e.g., primary and secondary) of the transformer may be considered inductive elements. The control signal 330 may be provided by the circuit controller 306 to control the operation of the transistor 312 as a switch that, when closed, connects the first inductor 316 to the power supply 302 such that a current from the power supply flows through the first inductor 316. The inductor values, the time and frequency of actuating the transistor, and other factors can be tailored to generate a waveform and particularly a waveform with controlled harmonics to the battery for charging the same. With reference to the example charge signal illustrated in FIG. 2, the signal at node 336 may be a series of pulses between 0 volts and the about the rail voltage, e.g., the voltage at node 334 provided by the power supply 302. The pulses at node 336 may be of varying duty cycle and may be generated at varying frequency. Overall, however, the pulses are generated to produce a signal that is the same or nearly the same as the intended charge signal. So, for example, a signal like FIG. 2 would be at node 338 based on the combination of pulses present at node 336. Depending on the signal, 10s to 1000s (or more) pulses may be generated to form the desired charge signal.

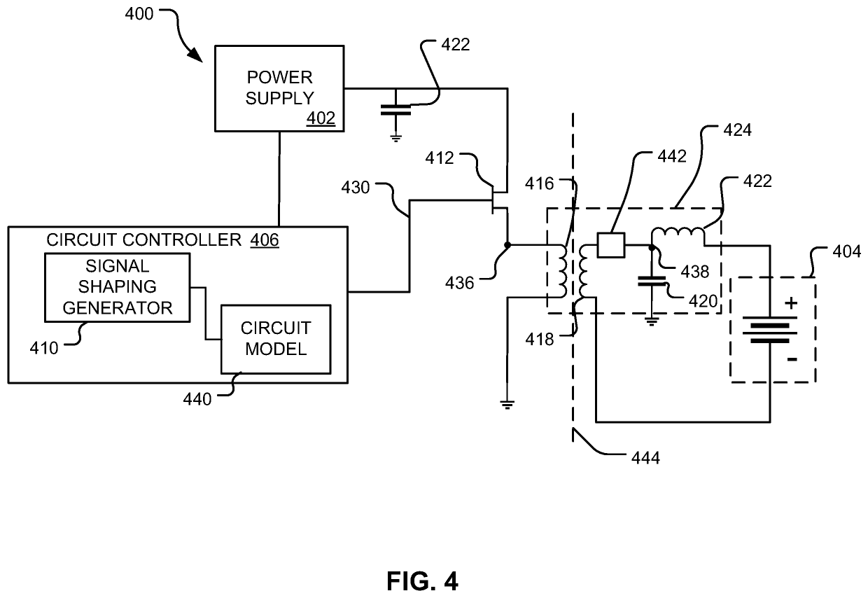

In addition to the first inductor 316, other components may be included in the circuit 300, some of which are shown in FIG. 4. In particular, the circuit 400 may include a first capacitor 422 connected between the output of the power supply 402 and ground. As discussed in more detail below, some of the energy required for a charge waveform may be provided by a combination of the power supply and the capacitor 422. On the battery side of the system, on the batter side of the wireless gap 444 between the inductors, in a portion of the circuit referred to as filter 424 and as shown in FIG. 4, a second capacitor 420 may be connected between second inductor 418 (at node 438) and ground. The second inductor 418, when positioned proximate the first inductor 416, translates the charge signal generated in the first inductor from the pulses at node 436. The second inductor is coupled with an anode of the battery 404. Alternatively, also as shown in FIG. 4, an inductor 422 may be connected to the transformer inductor 418 at the capacitor 420. The filter 424 of the circuit 400 may operate, in general, to prevent rapid changes to the charge signal applied to the battery 404. The filter may also convert the pulses at the input of the filter to a charge signal as well as filter any unintended high frequency noise from the battery. For example, upon closing of the first transistor 412 based on control signal 430, first inductor 416 and second inductor 418 and the transformer formed thereby when proximately positioned may prevent a rapid increase in current transmitted to the battery 404. Such rapid increase in current may damage the battery 404 or otherwise be detrimental to the life of the battery. Moreover, the inductor 416 or inductors 418 and 422, alone or in combination with capacitor 420, may shape the waveform applied to the battery, and control of the signal applied to the inductor 416 may provide for controlled shaping of the waveform.

In another example, capacitor 422 may store energy from the power supply 402 while first transistor 412 is closed. Upon opening of the first transistor 412, which may be accompanied by closing transistor 414, the capacitor 420 may provide a small amount of current to the battery 404 through second inductor 418 to resist an immediate drop of current to the battery and may similarly be used to controllably shape the waveform applied to the battery, particularly avoiding sharp (high frequency) negative transitions. The filter circuit, which in FIG. 4 may include inductor 422 and capacitor 420, also removes other unwanted signals such as noise which may include relatively high frequency noise. Other advantages for charging of the battery 404 are also realized through filter circuit 424 but are not discussed herein for brevity.

It should be appreciated that more or fewer components may be included in charge circuit 300 or 400. For example, one or more of the components of the filter circuit 324 (424) may be removed or altered as desired to filer the charge signal to the battery 304 (404). Many other types of components and/or configurations of components may also be included or associated with the charge circuit 300 (400). Rather, the circuit is but examples of a battery charging circuit and the techniques described herein for utilizing a circuit model for generating or otherwise determining control signals for shaping a charge signal may apply to any number of battery charging circuits. Additionally, various additional combinations of inductors or capacitors may be provided in series or parallel to those illustrated, with some of such various examples described below with regard to the various alternative wireless charging arrangements.

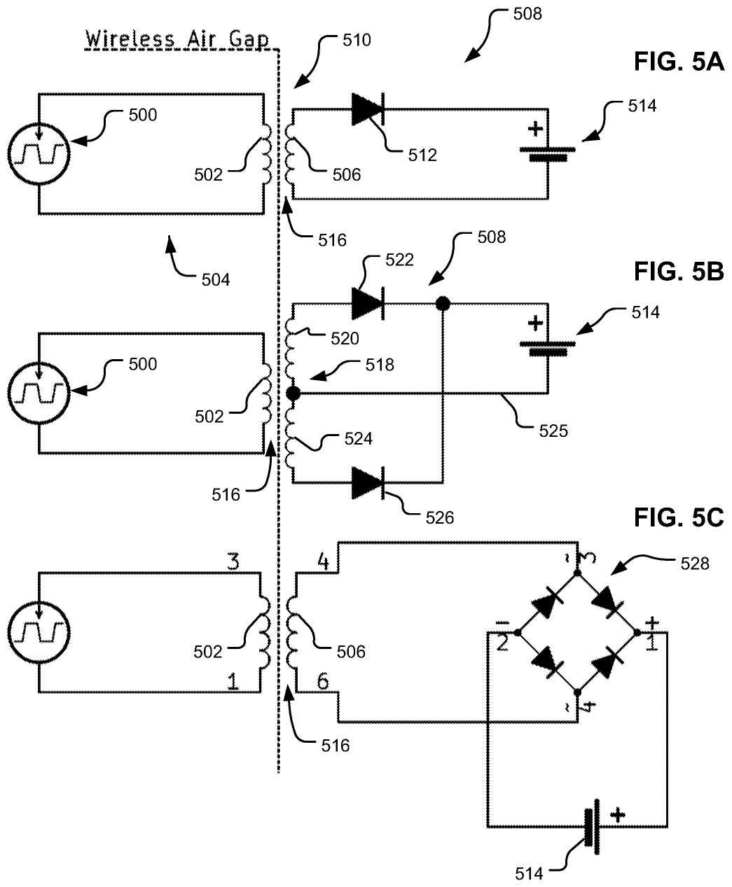

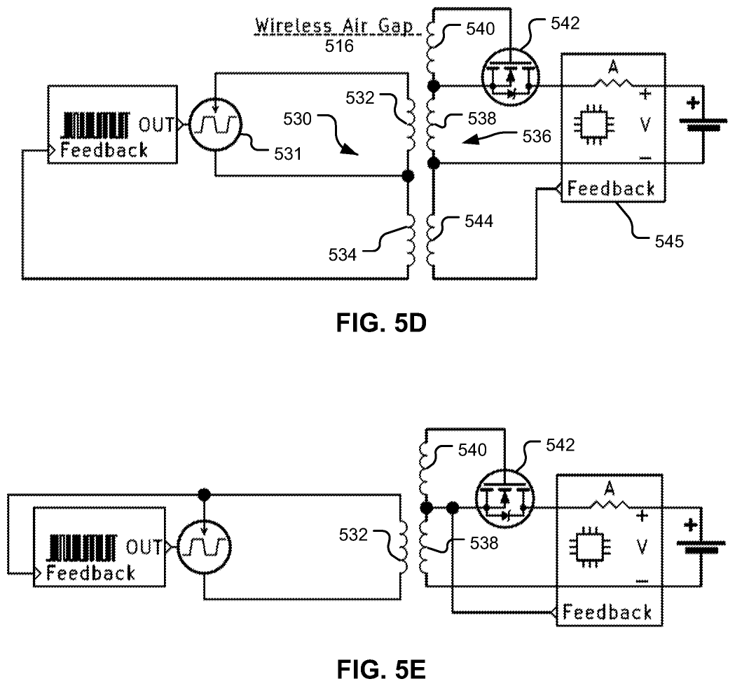

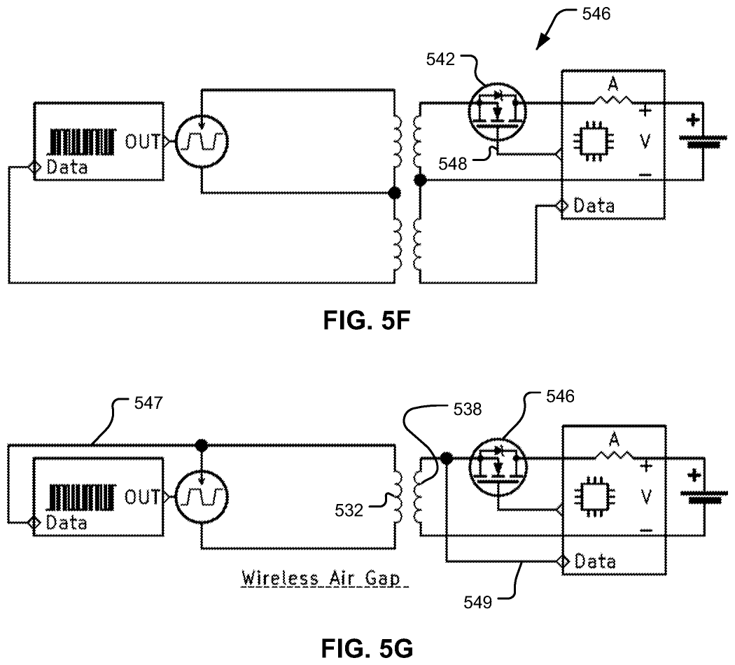

As described above, the signal shaping generator of the circuit controller may control the shape of the charge signal based on the model and/or feedback measurements of the battery received from the respective battery measurement circuit. For example, and referring to either FIG. 3 or FIG. 4, or the various alternatives discussed with reference to FIG. 5, an initial charge signal may be applied to the battery and one or more measurements of the battery (such as a current into battery or a voltage across the battery) may be obtained by the battery measurement circuit. These measurements may be provided to the signal shaping generator which may, in turn, determine an error between an expected measurement of the battery characteristic and a measured value at the battery. Based on this determined error, the signal shaping generator may control, via control signals, the first transistor and the second transistor to adjust the shape of the charge signal to the battery. In other words, the signal shaping generator 310 may sculpt the charge signal transmitted to the battery 304 to generate an expected measured characteristic of the battery. As long as the feedback measurements are expected, the shape of the charge signal may be maintained by the signal shaping generator via the control signals. A detected difference between an expected measurement and a measured value, however, may cause the circuit controller to alter the shape of the charge signal to bring the battery response into an expected range of values. Such a process may not be done, may be done at the initiation of charge, at various time during charge, may be done periodically or intermittently, or may be done in response to some change or some metric (e.g., change in terminal voltage, state of charge, temperature).

In some instances, the feedback techniques used by the signal shaping generator to alter or shape a charge signal to a battery may arrive too slowly to effectively shape a fast-occurring charge signal. For example, a charge signal may include pulses occurring at a particular frequency, often the same or faster than the battery measurement circuit can obtain battery characteristic measurements and/or the circuit controller can adjust the shape of the charge signal in response to measured battery characteristics. As a result, a circuit controller utilizing feedback measurements to adjust a shape of a charge signal is often unable to fine-tune the charge signal for optimal battery charging, particularly at a high-frequency charge signal.

FIG. 4 is a schematic diagram illustrating an alternative circuit 400 for charging a battery 404 utilizing a circuit model 440 in accordance with one embodiment. Various aspects of FIG. 4 have already been introduced above. The circuit 400 of FIG. 4 is an alternative version of the charge circuit 300 described above with reference to FIG. 3 and may include similar components, such as a power supply 402, a transistor 412 or other type of electronic switch, battery 404 and circuit controller 406. While not shown, a battery measurement configuration may also be included. Like above, the transistor 412 may be controlled by a control or input signal 430 to operate the transistor as a switch and alternately connect an inductor 416 to an output of the power supply 402. The filter may be considered the inductor 416 and may also include capacitor 420 and/or second inductor 422. In general, the transistor 412 may be any type of FET transistor or any type of controllable switch device. The control signal 430 may be provided by the circuit controller 406 to control the operation of the first transistor 412 as a switch that, when closed, connects the inductor 416 to the power supply 402 such that the charge signal from the power supply flows through the inductor 416 and inductor 418 through action of the transformer formed therebetween.

In a variety of applications, cost and complexity may be issues that are to be minimized or avoided, if possible. The use of the model may avoid having to monitor values at discrete components and may avoid more complicated feedback measurements and control. In some instances, the circuit model may model the components external to the circuit controller, such as power supply, transistor, inductors, particularly when forming a transformer after placing them in proximity, and the battery itself to determine how to generate a particular target shaped charge waveform at the battery.

The components included in the model may have variable attributes to determine the effect of the component on an applied charge signal and adjust the model by adjusting the variable attributes of one or more of the modeled components. For example, the model for the inductors, or more particularly for the transformer formed by the two inductors when the charger and device are positioned to charge the battery of the device, may include an inductance value and a series resistance value. The battery itself may be modeled with an inductor and resistance and may be arranged in series. Other modeled components, such as the switch and/or the battery may also include various attributes to improve the accuracy of a simulation performed on the modeled components. Further, the attributes of the modeled components may be adjusted over time based on performance data, a characterization sequence, or other feedback data from the circuit components or based on calculation or a characterization method. For example, the charge signal of the circuit of FIG. 4 may be sampled and fed back to the circuit controller at various points and a comparison of the received charge signal to an expected charge signal may be made by the controller. Based on a difference, the circuit controller may alter or adjust one or more attributes of the components of the model to improve the accuracy of the model. The adjustments to the model components may be repeated over a period of time such that the adjustments may account for parasitic effects to the components.

FIG. 5 illustrates several different wireless charging topologies. The illustrated charging topologies do not illustrate all of the various components involved in generating the signals at the input side of the wireless interface such as the model, controller, switch and the like but instead focuses on various features of the wireless portion of the interface and other components not already discussed above with reference to FIGS. 1-4. It should be recognized that various attributes discussed with reference to FIGS. 1-4, however, may be involved in the generation of a charge signal using the wireless features emphasized in FIG. 5, and similarly features of the various embodiments of FIG. 5 may be integrated, alone or in various combinations with those embodiments illustrated in the preceding figures.

FIG. 5A illustrates a topology generally introduced with reference to FIG. 3. Here, a series of pulses or other control signals 500 are provided to the input side of an inductor 502 on the charger side 504 of the illustrated system. The first inductor, when placed proximate a second inductor 506, which may be a component of a device 508 including a battery to be charged, forms a transformer 510. In the various examples discussed herein, the first inductor may be referred to as the primary winding of the transformer with the second inductor referred to as the secondary winding of the transformer; however, this language is only used for convenience and the primary/secondary relationship may be reversed, and the terms may not be applicable to every possible “transformer” configuration formed in the various wireless charging embodiments.

As shown in FIG. 5A, as well as FIG. 3, a diode 512 is shown between the second inductor 508 and the battery 514. The diode prevents the battery from discharging through the secondary side of the transformer. In this example, the diode may also be a part of the model. The diode may also act as a half wave rectifier. So, should the control pulses on the input side of the transformer include a negative component resulting in a negative charge signal component, the diode will only allow positive current to flow and block any negative portion of the signal from being applied to the battery.

FIG. 5B is another alternative wireless charger, again with some components of FIGS. 3 and 4 not shown. FIG. 5B includes the same primary side inductor 502. However, on the secondary side, across an air gap 516, on the side 508 of the wireless charging system, the secondary of the formed transformer is comprised of a center-tapped secondary 518 (an inductor segmented with a tap). The upper half 520 of the inductor is connected with a first diode 522 and operates like FIG. 5A. The lower half 524 is connected to a second diode 526. The battery return 525 (a connection with the negative post (or tab, etc.) of the battery) is connected at the center tap. The combination of the center tap secondary, the return path and the addition of the second diode forms a full wave rectifier configuration. Here, rather than simply blocking transmission of any part of the signal 500 that may be negative, the second diode inverts any negative signal 500 to a positive signal.

FIG. 5C is a wireless charging configuration with a primary 502 and a secondary 506 that positions a full bridge diode rectifier 528 across the secondary winding (inductor) 506 and connects the battery 514 to the bridge. The bridge, like the full wave rectifier configuration of FIG. 5B, inverts any negative portion of the charge signal formed at inductor 506.

In terms of modeling, besides modeling some combination of components, e.g., the transformer (e.g., the inductor or inductors of the charging side device and the inductor or inductors of the device of the battery to be charged), switch (e.g., transistor or diode) in a wireless charging environment, the system may account for the air gap 516 formed between the respective inductors (transformer windings) when the battery side device is positioned proximate the charge side device. As discussed, to wireless charge the battery, the device with the battery must be positioned proximate the charging device so that the windings present in the respective devices form a transformer. In some implementations, there may be a mechanical interlocking and/or positioning feature that forces the respective transformer components to be positioned repeatedly in the same arrangement, and forming a repeatable air gap, so that the aspects of modeling are consistent and not effected by air gap variability. In one example, they system may include a shaped receptacle of the charger (or shaped plug) and a matching shaped plug (or receptacle) of the device including the battery such that the devices interconnect in one way that predictably mechanically aligns the transformer components with a consistent air gap. The shaped plug may be formed into the body of the device housing the battery. Other mechanical features may also be used like a keyed or shaped pad with a matching key and shape, for example. In the example of a rechargeable watch, the back housing of the watch may include a defined shape or a key feature that aligns with a receptacle of the charger.

In other possible implementations, however, there may be a random placement of the charging device relative to the charger and hence the air gap may not be as mechanically predictable. Relative positioning of the inductors, depending on their shape among other things, may also be inconsistent. In such cases, adaptation of the model may be advantageous to account for such issues during any given charge cycle, which may be managed through the calibration process discussed further below.

In various implementations alone or in combination with adjusting for air gap variability, it may also be desirable to achieve the function of a diode or diodes without the losses of a conventional diode. FIGS. 5D-5G include wireless charger topologies including a transistor in place of a diode, and various possible wireless feedback paths for modeling and other purposes, among other distinctions from the topologies illustrated in FIGS. 5A-5C. FIG. 4 also shows such a transistor 442. It should be recognized that various features of FIGS. 5D-5G may be combined, alone or in combination, with other features discussed herein relative to other figures to form entirely new possible implementations, and various features of FIG. 5 or other figures may or may not be included in any given implementation.

Beginning with FIG. 5D, the transformer winding (e.g., primary inductor) on the charger side is a split winding 530. It should be recognized that the windings may be unevenly split meaning there may be more or less windings in the respective first 532 and second 534 part of the primary winding (the same being possible with other split winding embodiments discussed herein) The device side windings (e.g., secondary inductor windings 536) are also split or otherwise form three distinct winding areas, which, like other split winding configurations discussed herein, may be achieved with a split or tapped winding, distinct windings, or combinations thereof, and may have different numbers of windings in the three different portions. The first portion 532 of the charger side winding may be considered an inductor that is switchably controlled with pulses 531 to form a target charge signal. That target charge signal is reproduced across the gap 516 in the respective first part 538 of the device side winding. The third part 540 of the device side winding is used to actuate a switch 542, e.g., a transistor, when there is a charge signal pulse present on the first portion 532 of the device side winding during charge. In more detail, the charge signal will be positive and some portion of the charge signal is reproduced in the upper 540 (third part) of the device side winding. The number of windings may be tailored to ensure that when there is a charge signal, within a range of possible values, there is a sufficient signal from the third secondary winding to drive on the switch 542. The switch is driven on, with very little loss across the transistor, to pass the charge signal to the battery. The intrinsic diode of the transistor blocks reverse current. In one example, the third part of the secondary winding has a relatively higher number of windings than the first part 538 of the secondary winding. In this way, the voltage level may be sufficiently positive to turn on the switch, even when the amount of charge current and hence pulse level at the primary first winding and secondary first winding are relatively low at different points in a charge signal.

In various possible arrangements, it may be useful to obtain information, at the charger, from the battery. The FIG. 5D embodiment includes a distinct transformer portion including a lower, second part 534 of the primary winding, which as noted may be a completely separate winding as opposed to the tapped winding shown, and a distinct complimentary lower (second) 544 portion of the secondary winding on the device side. Feedback measurements of the battery from a battery monitoring component 545, which may obtain information like discussed above relative to FIGS. 3 and 4, and other components may be asynchronously transmitted through the feedback transformer arrangement formed from the second part of the primary winding and the second part of the secondary winding. Feedback may be used for modeling, verification, monitoring and other functions discussed herein. Feedback may be by way of serial communication using the feedback inductor path, which is also possible in other embodiments discussed herein.

FIG. 5E illustrates another alternative wirelessly charging embodiment. Here, the upper part of the secondary winding driving the switch may be the same arrangement as shown in FIG. 5D. However, the feedback path is different and is synchronized with the charge signal. As such, there is only a first primary side winding, the lower (second) portion of the primary winding is not present. In this example, feedback signals (e.g., battery measurement signals) are transmitted from the secondary side first winding 538 to the primary side winding 532. The signals are synchronously sent when the charge signal is zero (not on). As noted herein, there may be periods when the charge signal is zero—e.g., during a rest period in a charge signal or during a period purposefully defined for information transmission across the air gap. In such periods, current or stored battery data may be transmitted to the charger by way of the transformer. The feedback path may be triggered by determining or otherwise occur when the transistor is on or off, for example. When the transformer is off, there is no charge signal present and hence the battery measurement circuit may encode and transmit battery measurements to the charger by way of the transformer formed by inductors 538 and 532.

FIG. 5F illustrates another alternative wireless charging embodiment. In this embodiment, the feedback path is like that of FIG. 5D. Here, however, the device 546 containing the battery to be charged actuates the transistor 542. As shown, there is a control line 548 from the device under charge, which may be the battery monitoring circuitry, to the transistor gate. In this example, the battery side device may transmit a signal to the charger to initiate charge, which may use the same feedback path. At the same time, the device under charge may also activate the switch to allow charge signals to pass. During charge, the charger may send a signal through the feedback path to the device under charge when it is appropriate to provide battery measurement data, and the device under charge may then also open the switch. In this example, a processing unit on the device under charge side receives and transmits various signal and controls the transistor. This may be a processing unit separate or the same as a battery measurement unit that monitors and collects data about the battery before, during, and/or after charge. In another example, the control line may be connected from the charger to the transistor through a transformer, e.g., like the feedback path transformer of FIG. 5D.

Finally, FIG. 5G is another alternative wireless charging system. Here, there is only a single primary (inductor) 532 and secondary (inductor) 538 winding operatively forming a transformer when positioned. The charge signal pulses generate the charge signal on the primary side. Also on the primary side, a control line 547 sends a signal across the windings to a communication port 549 of the battery unit, which upon receiving a signal, activates the transistor 546 to allow the charge signal to pass. Feedback from the battery measurement system may be asynchronously transmitted through the same transformer from the communication port. In such a situation, when no charge signal is detected, the transistor may be deactivated, data transmitted across the transformer, and prior to reactivating the charge signal, the system may first send a charge start signal. The charge start signal may be a simple high voltage of some value or may be some binary sequence so that the battery unit may discriminate amongst possible control signals. In some instances, no charge initiation is required as the battery measurement data is transmitted well within any gap between active charge portions of a charge signal (e.g., during a rest period), and feedback simply initiated as soon as the charge signal is not present.

While not shown, it is also possible to provide feedback and control signals by way of Bluetooth or some other wireless communication protocol depending on the environment in which the wireless charger is implemented and other factors.

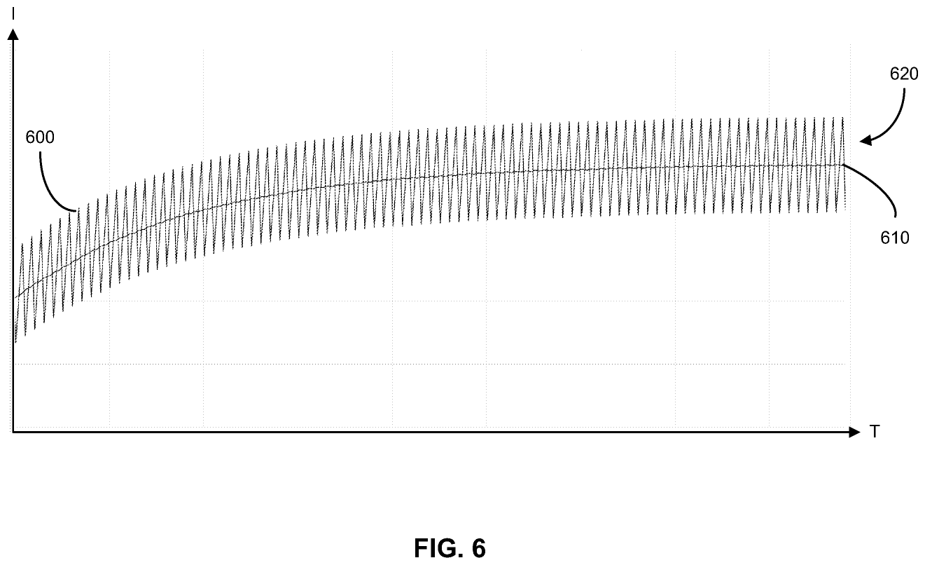

FIG. 6 illustrates another example of a portion of charge waveform. In the portion of the example illustrated, the charge waveform 600 at node 438 is overlaid with the charge waveform 610 at the input to the battery, after further processing by a second inductor 422 on the battery side and coupled to the secondary side inductor 418. Here, it can be seen that the charge waveform 600 at node 438 is an alternating signal, somewhat sinusoidal in shape, alternating about a nominal non-zero voltage 620 that is rising from left to right. Thus, control pulses at node 436 result in an alternating pattern and a nominal rising non-zero voltage. The pulse width and frequency can be controlled to produce the pattern at node 438 after processing by the transistors. The alternating charge signal at node 438 is then further processed in the second inductor 422 to produce a charge waveform 610 that is applied to the battery. The alternating pattern remains present but is substantial dampened by the second inductor such that its amplitude is dramatically less than at node 438, and the charge current is what is intended. The nominal value of the alternating pattern at node 438 after the transformer is effectively the remaining charge signal after the second inductor.

The controller 306 (406) uses the circuit model to generate the control signals for the switch to produce the desired charge waveform. In a charge sequence, the system may first calibrate the model. In one example, the model comprises a mathematical model of an inductor in series with a resistance. At a simple level, the model may comprise an inductor representative of inductor 416 and 418 (an inductor model of the transformer formed by the same). It should be noted that calibrations may be used to account for air gap variability, primary and secondary winding positioning variability, and other issues that may affect the portion of the model for the transformer. In another alternative, the model may comprise an inductor (or inductors) of inductors 416, 418 and 422. Further, the model may also include an inductor value of the battery being charged. Similarly, the model may include a resistance value accounting for various attributes of the filter circuit 324, for example, including battery resistance and wiring resistance (or whatever filter circuit is employed). In a model with an inductor value representative of the filter circuit transformer inductance and resistance, there may be a tunable or settable inductance value and a resistance value.

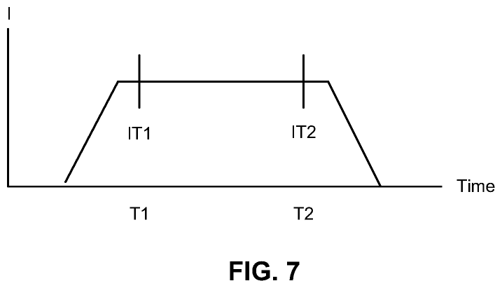

Calibration involves generating a test signal, which may be a charge signal or dedicated test signal and determining if the charge signal at the input to the battery matches the intended target signal. If the signal matches, then the model is considered accurate, and the model parameters are not adjusted. To determine a match, in one example, a calibration test signal is applied to the battery, an example of such a test signal being illustrated in FIG. 7. The calibration signal has a first target current (IT1) and a second target current (IT2). In one example and as shown, the first and second target currents are intended to be the same and the test signal has a flat top and a generally trapezoidal shape, as shown, with a gradually rising leading edge and a gradually falling trailing edge. As noted elsewhere, the target and measurement may also be a target voltage and a measurement of voltage. To ensure that the current level of the test signal has settled, after the rising edge, the measurements at time T1 is taking some time after the transition to the flat top. Similarly, to help ensure that the second current is measured before the signal begins returning to zero, the second measurement is taking before the falling edge of the test signal. The system, such as through the battery measurement circuit 308, which may also be present in the example of FIG. 4, or the various measurement circuits of FIG. 5 asses the actual current at time T1 and at time T2, and compares the actual current measurements at each time to the expected first and second target currents at the respective times. Feedback is achieved through the various techniques discussed herein including those of FIG. 5.

The goal of calibration is to have the actual measurements, whether voltage or current, at T1 and T2 match those of the target, which indicates that the model matches actual circuit performance. As noted above, model calibration may also address variabilities in the wireless charging environment from primary and secondary winding placement to form the transformer. The calibration technique may adjust the inductor value of the model and/or the resistance value of the model. While actual measurement comparisons of the currents at times T1 and T2 can be compared to the target currents, in one example, a more computationally simple difference technique is employed. Namely, the system includes a comparator that determines if current (or voltage) at time T1 is greater or less than the target current (or voltage) at time T1 and does the same at time T2 relative to the target current (or voltage) at time T2. When one value matches and the other does not, the system adjusts the inductor value. Similarly, when one value is higher than the target current and the other signal is lower than the target current, the system adjusts the inductor value. In either case, the differences are indicative of a test signal with a sloped top as opposed to the targeted flat top, and a sloped top is indicative of mismatch in the model inductance. In contrast, if both measured values are greater or less than the respective target values, it is indicative of a mismatch in the model of the resistance. If the measured voltages, in the example of test and measurements using voltage, are less than the target, then the resistance is decreased, and if the measured voltages are greater than the target, then the resistance is increased. Of course, both inductance and resistance may need calibration. The system, in one example, iteratively adjusts the model by repeatedly running the test signal, adjusting the inductance and/or resistance, and measuring the current (or voltage) at times T1 and T2 until the measured values match those of the target at both times. The model may be considered calibrated when the measured voltages are within some percentage or threshold in relation to the target, e.g., within 0.01%, 0.1%, 1%, or some other tolerance depending on any particular implementation, the accuracy specified or required for the application, etc.

After model calibration, the system may begin charging. Alternatively, the system may further calibrate the model to ensure that the pulse sequence at the filter input will generate the target waveform. In some examples, the model also includes the switch that produces pulse sequences at the input of the filter to produce the target charge waveform. The model is programmed to produce a target voltage and/or target current commensurate with the target waveform at any specific point in time. Pulses at 336 produce that target waveform after processing by the filter (the various possible combinations of charge signal forming components discussed herein). In one example, such as to produce the target waveform of FIG. 2, the target waveform has a distinct beginning time and ending time, where the signal transitions from zero voltage (and/or zero current depending on how measured and/or controlled) to a non-zero value of the target charge waveform. The same occurs at the ending time, where the voltage and/or current transition to zero from the non-zero value of the charge waveform. It is also possible to momentarily drive the charge current below zero between charge signals. In various possible examples, the discrete charge waveform is repeated some number of times, which may be substantial and account for a significant change in charge percentage, and until the system determines some change in the charge control is needed, which can be changed to the charge signal and/or a recalibration of the model. Regardless, the model may further calibrate itself by generating a target pulse sequence into the calibrated filter elements of the model, to ensure that the desired target signal is generated by the model. This part of the calibration may be done through running an intended signal through the model and without measuring actual circuit performance or the actual charge signal. The switch control may be adjusted in any number of ways to adjust pulsing of the filter circuit to produce the target waveform. For example, the on time of switch 312 may be adjusted to produce pulses of different width, and the frequency of pulsing at 336 may also be adjusted. The width and frequency of pulses needed to produce a charge signal of the variety of shapes desired, and the value of the shape at a very particular point in time, may vary across a nearly infinite combination of pulses to produce a myriad of possible charge signal shapes and patterns. Nonetheless, the system may iterate the switch control until the modeled filter circuit is producing the desired target charge waveform at the battery, and then beginning charging using the calibrated control and model to produce the charge waveform.

It should be recognized that calibration may not occur in every charge cycle and conversely aspects of calibration may occur within a charge cycle—a charge cycle being considered from the initiation of charge until charging end, either at 100% SOC or when ended otherwise. For example, the inductance and/or resistance of the filter circuit that are modeled may change during a cycle or over many charge cycles due to various electrochemical and electrodynamic effects of the battery over time and cycles, due to heat, due to charge current values and other reasons; similarly, circuit elements may change due to heat and cycles among other reasons. It should be also recognized that different elements of the filter circuit may have different effects on the accuracy of the modeled circuit performance. For example, capacitor 320 may be present in the filter but its value may not have a significant effect on modeled performance and hence its value is not included in the model. Similarly, other components outside the filter circuit may be modeled such as the power supply. Similarly, capacitor 322 may be modeled.

In one example, as noted above, the target waveform may be a repeated shaped charge signal, and the charge signal may be at a zero state between repeating shaped charge signals. The zero state may allow any minor errors in the filter circuit production of the targeted shape to not propagate across subsequent shapes. Moreover, in a synchronous feedback scheme discussed with reference to FIG. 5, wireless feedback signals of battery measurement may be transmitted during a zero state. Additionally, capacitor 322 is included to ensure that the system has sufficient charge energy to produce the targeted shape. In some instances, if the power supply is insufficient on its own to produce a charge current and voltage at a particular point in time of the target charge waveform, then the capacitor stores energy to meet that demand. Between target charge signals, the capacitor may recharge so that it has available energy for the next sequence. Given this role in overall charge signal delivery, capacitor 322 may also be modeled and considered during calibration, such as control signal calibration.

Regardless, when the model is calibrated and/or the switch control and pulsing of the filter circuit are calibrated, the system initiates charging.

Further still, the charging circuits and methods described herein may apply to a battery comprising a single cell or multiple cells. In a multiple cell configuration, the cells may be arranged in a series configuration, a parallel configuration, or a combination of series and parallel configurations. Multiple battery cells arranged in a series configuration may reduce the overall current used to charge the battery cells as the current is divided among battery cells in the series connection. By connecting the battery cells in series, the charging circuits may require less current, further improving the efficiency of the charging circuit.

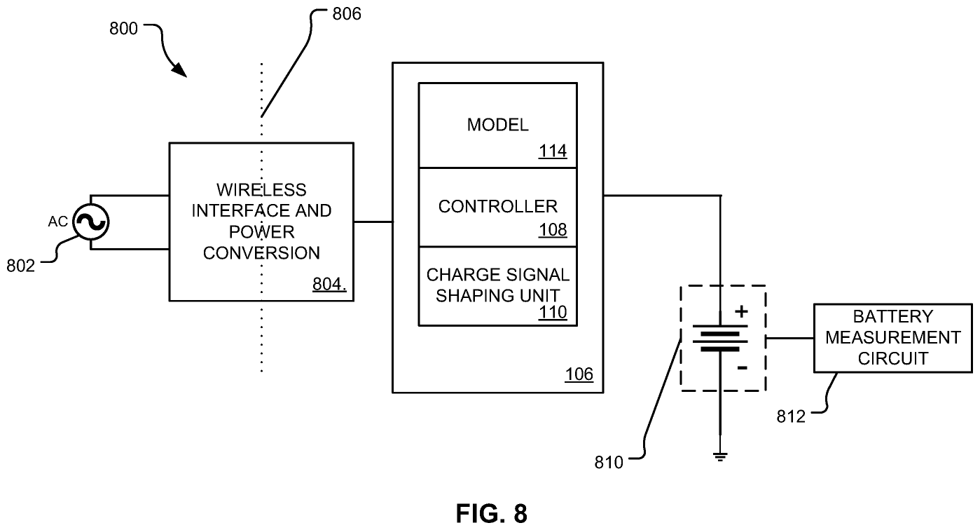

FIG. 8 is an alternative example of a wireless system 800 according to various aspects of the present disclosure. In this example, a power source 800 (here, shown as an AC source, which may be from a common wall outlet) is coupled with a wireless interface 804. The interface, as discussed in other examples herein, may include a pair of inductors or otherwise a pair of coils of a transformer that is formed at the interface. In the example illustrated, one inductor or coil is coupled with the power supply. While various possible arrangements are possible, in one example, the inductor or coil is positioned within a housing and a power cord connects the coil to the power supply. In the case of a wall outlet, the voltage level or other signal conditioning may be necessary in some arrangements. Similarly, if the power source is DC, than DC to AC conversion may be required to provide an AC signal to the inductor.

On the other side of the air gap 806, at the wireless interface 804, there is a second inductor (e.g., the other coil of the transformer). In various possible arrangements, the second inductor may be within a housing, which may be of or in electrical communication with a battery pack or may be part of the device including the battery 810 to be charged. The wireless interface may also include power conversion electronics of various possible types that converts the AC signal at the second inductor to a DC signal.

The system includes a processing unit 106 along with a model 112, controller 108 and a charge signal shaping unit 110, discussed herein in association with various embodiments. Based on control and shaping, a shaped charging waveform may be applied to the battery to charge the same. The system may further include a battery measurement unit 812 that may provide various possible parameters including terminal voltage, charge current, and/or temperature back to the unit 106 for various charge purposes.

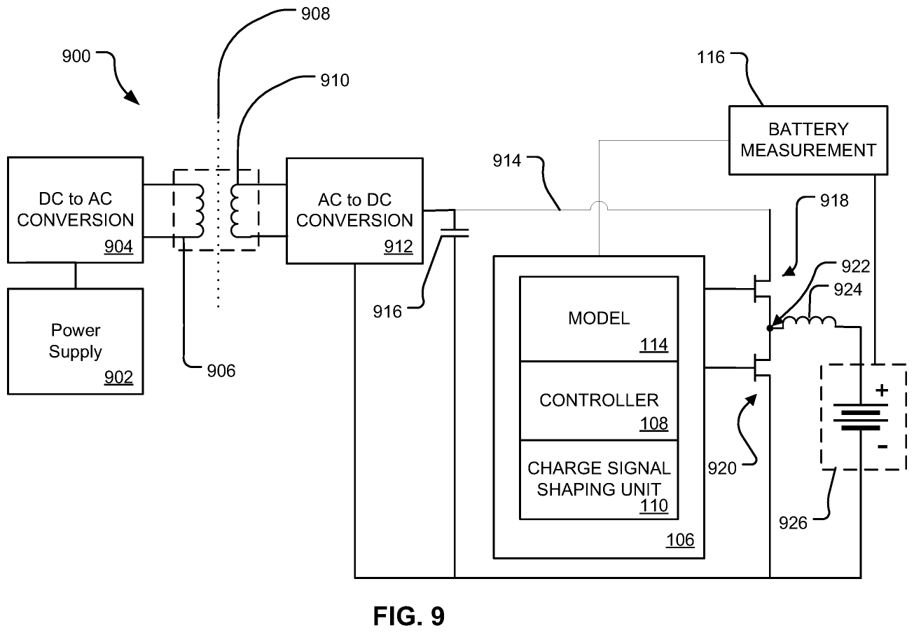

FIG. 9 is yet another example of a wireless system 900 according to various aspects of the present disclosure. Here, a power supply 902 is DC, and on the power supply side of the system, there is also DC to AC conversion 904 as the transformer formed at the wireless interface requires an AC signal of some form. The DC to AC converter, also referred to in specific situations as an inverter, may encompass a large number of possible circuit arrangements that convert a DC signal to an AC signal. As with other embodiments discussed herein, the AC power is applied to an inductor 906 on one side of an air gap 908, which AC power is transferred to a second inductor 910 when the two inductors are proximately positioned to form a transformer. In this example, the power supply, DC to AC converter and first inductor may be a part of one assembly, with the various elements either housed in one housing or interconnected through cabling or otherwise.

The second inductor 910 is operably connected with an AC to DC converter 912, which may be a form of rectifier or other AC to DC converter type. The DC signal from the converter is applied to a power rail 914. The rail may include a capacitor 916 that may provide a cleaner DC signal and source additional power to the rail if needed. A pair of switches 918 and 920 are coupled with the rail and controlled by the processing unit 106. A series of controlled pulses at node 922, from the switches, produces a shaped charge waveform by way of inductor 924, which is applied to battery 926. As with other embodiments, the system may also include a battery measurement unit, which may be discrete components coupled with the battery, and provides battery and/or charge information back to the unit 106 to shape and otherwise control charging.

In the examples of FIGS. 8 and 9, the model may be of the inductor as opposed to one or more components of the transformer, e.g., the inductor or inductors forming the primary and second side of a transformer formed at a wireless interface of FIG. 3 for example. As with other examples, a charge signal shaping algorithm may provide an expected or intended charge signal for charging a battery. The model may be used to confirm and/or adjust the controls for generating the signal. The model may also, based on the intended charge signal, output one or more control signals to switches or other components of the charge signal shaping circuit based on a modeling of the components of the charge signal shaping circuit. In some instances, aspects of the shape of the shaped charge signal may correspond to a harmonic (or harmonics) associated with an optimal transfer of energy to the battery, although the purpose of the system is to be able to efficiently generate a shaped charging signal, which may be of any arbitrary shape determined or otherwise defined by the system, and apply the same to the battery, among other goals. The shape, which may include the content of the charging signal, which may be any arbitrary shape defined by the controls, is defined and/or controlled. The control signals to the components of the charge signal shaping circuit may be based on a model of the components of the shaping circuit, including components of the wireless interface, rather than strictly based on a feedback of measurements of the charge signal at the battery or of the battery itself during charging such as voltage and current, which are typical of battery charging circuits. In some instances, this approach may be referred to as a “feed-forward” technique.

As introduced above, rather than an extensive feedback environment using detailed feedback of various signal and battery characteristics, the charging system may use a model. In the example of FIGS. 8 and 9, the model may be of an inductor, which may also include a resistor in series with the inductor, where the configurable inductor value is representative of inductor 924, for example. The model may include other modeled values as well depending on any components in addition to an inductor as well as the battery being charged. The model may thus be an inductor value, which may also be in series with a resistance value. In the presence of a controlled sequence of pulses at the input to the model, the model can predict the charge signal output to the battery. So, for example, a sequence of pulses at node 922 may produce a signal like shown in FIG. 2 or FIG. 6 at the battery. In other examples, the model may further include switch elements, such as 918 and 902, as well as an AC to DC power converter (which may also include elements of the wireless interface and power supply providing power to the converter) and the capacitor 916. The model thus may also be able to model the control sequences to the switches that produce the input pulses to the shaping inductor (e.g., inductor 924) that receives the sequence of pulses to form the shaped charged waveform (which shaping inductor may also be considered a filter alone or in combination with the other elements such a capacitor or additional inductors shown in various other examples operably coupled with whatever the shaping inductor whether part of a transformer or otherwise) and analyze the modeled charge waveform produced by the model. Since various aspects of the present disclosure involve generating a carefully controlled charge waveform that is not a conventional and simple constant current, constant voltage or square edged pulse type charge signal, accurate reproduction of a targeted or planned charge signal into an actual charge signal is important and produced by the system. Moreover, in many charging environments the use of the model is beneficial as overly complicated measurement and feedback systems are too expensive, consume too much energy, are too slow, consume to much processor architecture real estate or the like to be practical and/or effective.

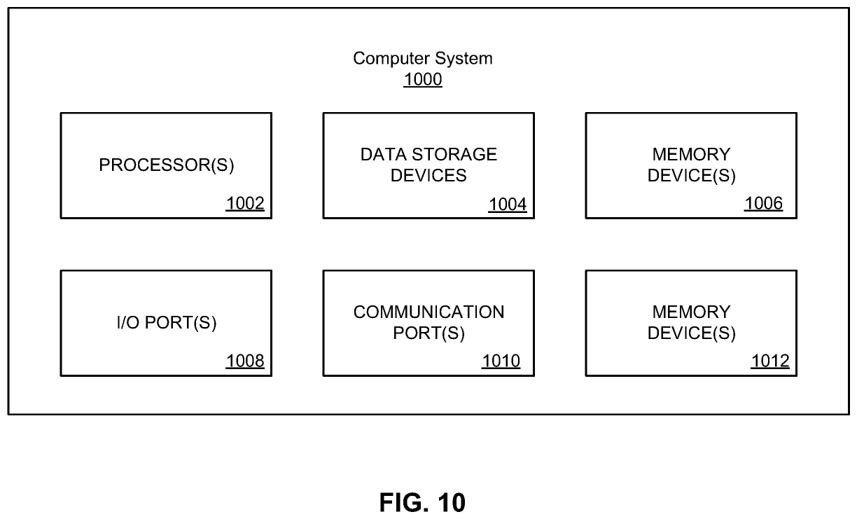

Referring to FIG. 10, a detailed description of an example computing system 1000 having one or more computing units that may implement various systems and methods discussed herein is provided. The computing system 1000 may be part of a controller, may be in operable communication with various implementation discussed herein, may run various operations related to the method discussed herein, may run offline to process various data for characterizing a battery, and may be part of overall systems discussed herein. The computing system 1000 may process various signals discussed herein and/or may provide various signals discussed herein. For example, battery measurement information may be provided to such a computing system 1000. The computing system 1000 may also be applicable to, for example, the controller, the model, the tuning/shaping circuits discussed with respect to the various figures and may be used to implement the various methods described herein. It will be appreciated that specific implementations of these devices may be of differing possible specific computing architectures, not all of which are specifically discussed herein but will be understood by those of ordinary skill in the art. It will further be appreciated that the computer system may be considered and/or include an ASIC, FPGA, microcontroller, or other computing arrangement. In such various possible implementations, more or fewer components discussed below may be included, interconnections and other changes made, as will be understood by those of ordinary skill in the art.

The computer system 1000 may be a computing system that is capable of executing a computer program product to execute a computer process. Data and program files may be input to the computer system 1000, which reads the files and executes the programs therein. Some of the elements of the computer system 1000 are shown in FIG. 10, including one or more hardware processors 1002, one or more data storage devices 1004, one or more memory devices 1006, and/or one or more ports 1008-1012. Additionally, other elements that will be recognized by those skilled in the art may be included in the computing system 1000 but are not explicitly depicted in FIG. 10 or discussed further herein. Various elements of the computer system 1000 may communicate with one another by way of one or more communication buses, point-to-point communication paths, or other communication means not explicitly depicted in FIG. 10. Similarly, in various implementations, various elements disclosed in the system may or not be included in any given implementation.

The processor 1002 may include, for example, a central processing unit (CPU), a microprocessor, a microcontroller, a digital signal processor (DSP), and/or one or more internal levels of cache. There may be one or more processors 1002, such that the processor 1002 comprises a single central-processing unit, or a plurality of processing units capable of executing instructions and performing operations in parallel with each other, commonly referred to as a parallel processing environment.

The presently described technology in various possible combinations may be implemented, at least in part, in software stored on the data stored device(s) 1004, stored on the memory device(s) 1006, and/or communicated via one or more of the ports 1008-1012, thereby transforming the computer system 1000 in FIG. 10 to a special purpose machine for implementing the operations described herein.

The one or more data storage devices 1004 may include any non-volatile data storage device capable of storing data generated or employed within the computing system 1000, such as computer executable instructions for performing a computer process, which may include instructions of both application programs and an operating system (OS) that manages the various components of the computing system 1000. The data storage devices 1004 may include, without limitation, magnetic disk drives, optical disk drives, solid state drives (SSDs), flash drives, and the like. The data storage devices 1004 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1006 may include volatile memory (e.g., dynamic random-access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1004 and/or the memory devices 1006, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 1000 includes one or more ports, such as an input/output (I/O) port 1008, a communication port 1010, and a sub-systems port 1012, for communicating with other computing, network, or vehicle devices. It will be appreciated that the ports 1008-1012 may be combined or separate and that more or fewer ports may be included in the computer system 1000. The I/O port 1008 may be connected to an I/O device, or other device, by which information is input to or output from the computing system 1000. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 1000 via the I/O port 1008. In some examples, such inputs may be distinct from the various system and method discussed with regard to the preceding figures. Similarly, the output devices may convert electrical signals received from computing system 1000 via the I/O port 1008 into signals that may be sensed or used by the various methods and system discussed herein. The input device may be an alphanumeric input device, including alphanumeric and other keys for communicating information and/or command selections to the processor 1002 via the I/O port 1008.

The environment transducer devices convert one form of energy or signal into another for input into or output from the computing system 1000 via the I/O port 1008. For example, an electrical signal generated within the computing system 1000 may be converted to another type of signal, and/or vice-versa. In one implementation, the environment transducer devices sense characteristics or aspects of an environment local to or remote from the computing device 1000, such as battery voltage, open circuit battery voltage, charge current, battery temperature, light, sound, temperature, pressure, magnetic field, electric field, chemical properties, and/or the like.

In one implementation, a communication port 1010 may be connected to a network by way of which the computer system 1000 may receive network data useful in executing the methods and systems set out herein as well as transmitting information and network configuration changes determined thereby. For example, charging protocols may be updated, battery measurement or calculation data shared with external system, and the like. The communication port 1010 connects the computer system 1000 to one or more communication interface devices configured to transmit and/or receive information between the computing system 1000 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 1010 to communicate with one or more other machines, either directly over a point-to-point communication path, over a wide area network (WAN) (e.g., the Internet), over a local area network (LAN), over a cellular (e.g., third generation (3G), fourth generation (4G), fifth generation (5G)) network, or over another communication means.

The computer system 1000 may include a sub-systems port 1012 for communicating with one or more systems related to a device being charged according to the methods and system described herein to control an operation of the same and/or exchange information between the computer system 1000 and one or more sub-systems of the device. Examples of such sub-systems of a vehicle, include, without limitation, motor controllers and systems, battery management systems, and others.

The system set forth in FIG. 10 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments, also referred to as implementations or examples, described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment”, or similarly “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

What is claimed:

1. A system for charging a battery comprising:
a switch;
a transformer in operable communication with the switch; and
a processor in communication with the switch and in communication with a model of the transformer, the processor configured to execute instructions to control the switch to generate a sequence of pulses at the transformer to produce a shaped charge waveform responsive to running the model to generate the shaped charge waveform.

2. The system of claim 1 wherein the switch is operably coupled with a power supply and the processor is further configured to execute the sequence of pulses with the model and adjust the sequence of pulses to produce the shaped waveform.

3. The system of claim 1 wherein the model comprises a configurable inductance value and a configurable resistance value, and wherein the processor is further configured to execute instructions to calibrate the model by applying a known signal to the transformer and obtaining a first measurement at a first point on the known signal and a second measurement at a second point on the known signal, and changing at least one of the configurable inductance value or the configurable resistance value when at least one of the first measurement at the first point or the second measurement at the second point does not match a respective first intended measurement at the first point or a second intended measurement at the second point.

4. The system of claim 3 wherein the first measurement is a first current or a first voltage, the second measurement is a second current or a second voltage, and the respective first intended measurement is a first intended current or first intended voltage and the respective second intended measurement is a second intended current or a second intended voltage.

5. The system of claim 1 wherein the processor comprises a microcontroller.

6. The system of claim 1 wherein the sequence of pulses is at a primary winding of the transformer.

7. The system of claim 6 wherein the switch is a transistor.

8. The system of claim 7 further comprising a secondary winding of the transformer, and a battery operably coupled with the secondary winding to receive the shaped charge waveform.

9. The system of claim 1 wherein the model comprises an inductor value representative of transformer.

10. The system of claim 9 wherein the model further comprises a resistance value representative of the transformer.

11. A system for charging a battery comprising:
a first switch receiving power by way of a wireless interface;
a first inductor in operable communication with the first switch; and
a processor in communication with the first switch and in communication with a model including the first inductor, the processor configured to execute instructions to control the switch to generate a sequence of pulses at the first inductor to produce a shaped charge waveform responsive to running the model to generate the shaped charge waveform.

12. The system of claim 11 wherein the first inductor comprises a first side of the wireless interface, the system further comprising a second inductor comprising a second side of a wireless interface, the first inductor and the second inductor operably forming a transformer when proximately positioned relatively.

13. The system of claim 11 wherein the wireless interface further comprises a second inductor of a first side of the wireless interface, the second inductor forming a transformer when positioned proximately a third inductor of a second side of the wireless interface.

14. The system of claim 11 further comprising an AC to DC converter operably coupled with the wireless interface and converting an AC signal from the wireless interface to a DC signal operably applied to the first switch.

15. The system of claim 14 wherein the wireless interface receives AC power from a power source.

16. The system of claim 14 wherein the wireless interface receives power from a DC source and includes a DC to AC converter to provide an AC signal to a transformer of the wireless interface.

17. The system of claim 11 wherein the model comprises a configurable inductance value and wherein the processor is further configured to execute instructions to calibrate the model by applying a known signal to the first inductor and obtaining a first measurement at a first point on the known signal and a second measurement at a second point on the known signal, and changing at least one of the configurable inductance value when at least one of the first measurement at the first point or the second measurement at the second point does not match a respective first intended measurement at the first point or a second intended measurement at the second point.

18. The system of claim 17 wherein the first measurement is a first current or a first voltage, the second measurement is a second current or a second voltage, and the respective first intended measurement is a first intended current or first intended voltage and the respective second intended measurement is a second intended current or a second intended voltage.

19. The system of claim 11 wherein the processor comprises a microcontroller.

20. The system of claim 11 wherein the configurable inductor value is representative of the first inductor.

21. The system of claim 17 wherein the model further comprises a configurable resistance value.

22. The system of claim 17 wherein the model configurable inductor value is representative of a transformer of the wireless interface, the transformer including the first inductor.

23. The system of claim 11 further comprising a second switch in electrical communication with the first switch a common node in electrical communication with the first inductor.
